(19) United States
(12) Patent Application Publication
(10) Pub. No.: US 2006/0020481 A1
(43) Pub. Date: Jan. 26, 2006

(54) Method and system of managing a business center

(76) Inventors: Clement Lee, San Francisco, CA (US); Edwin Lam, El Cerrito, CA (US); Lawrence Choi, El Cerrito, CA (US)

Correspondence Address: Sean M. Fitzgerald, 3182 Campus Drive #342, San Mateo, CA, 94402-3123, US

(21) Appl. No.: 10/897,320

(22) Filed: Jul. 21, 2004

(51) Int. Cl. G06Q 99/00

(52) U.S. Cl. 705/1

(57) ABSTRACT

The present invention provides a method and system for managing, presenting and booking office space, conference rooms and other resources of a business center. Business center personnel may use the business center portal to manage the business center including managing the available business center facilities, generating reports, and generating work orders and work lists. Business center personnel may use the portal to create and change the details of business center facilities resources, equipment and services provided through the portal. Changes made to business center information at the portal are made in the business center's server, allowing the business center portal to be used to manage the business center's own servers and management system.

### BACKGROUND

1. Field of the Invention

The field of the invention relates generally to systems for maintaining and managing customer relationships. More particularly, the present invention relates to the field of managing a business center.

2. Related Background

Business centers have grown increasingly popular as the demand for temporary office space, meeting rooms and conference facilities has grown. Most business centers provide offices, conference rooms and other space on a rental basis by the hour, day, week, month, or longer. Often, these rentals are sporadic, where clients rent space in different locations or at different times on an as-need basis. This makes managing the use and availability of space a complex and challenging task, with customers requesting space on short notice and often changing or canceling reservations.

The need for efficient management of such space is heightened by the economics of the business center business. Business centers have high fixed costs in real estate, furniture, and equipment (such as projectors or video conference equipment). Profitability is highly dependent on the ability to maximize utilization of the business centers facilities.

Currently, business centers utilize brokers and online referral sites to generate business. Current referrals sites provide a general description of the facilities, such as the size, quality, and amenities. A potential client can enter their information and the referral site will forward the potential client's contact information to the business centers or business center brokers who contact the potential client. These referral systems do not provide real time availability information, as conventional referral systems are not integrated with the management systems used by business centers. Other than a referral, these systems provide little in the way of efficiencies or automation, leaving much of the process of booking space and billing clients to traditional manual methods.

Finding, comparing and booking business center facilities can be a time consuming and difficult process for the business center consumer. Using referral sites often leads to multiple brokers contacting the consumer, potentially after the consumer has booked with another broker. As conventional systems do not include comprehensive information from multiple business centers, and do not provide real time inventory and availability, consumers are unable to quickly and easily compare the available offices or other facilities resources from a wide range of business centers to find the business center that best meets their needs.

An example of current business center sites is given by Regus Business Centers (www.regus.com). Visitors are allowed to enter their contact information and some information specifying what their interests are, and a broker will contact them by phone or email.

The process of managing a business center is impacted by the bookings and occupancy of the business center's facilities. If a broker makes a booking that facility not only needs to be removed from the list of available bookings for potential customers, but business center staff need to know that the facility resource is scheduled to be occupied to ensure it is ready for the customer, including any special needs of the customer. As customers sometimes request additional space at the last minute, for example an office customer may request the use of a conference room in the afternoon for a last minute meeting, business center employees and managers need to have accurate, up to date information on the availability of business center facilities resources.

To provide clients with the best possible service, and to increase revenue, business centers need to manage the amenities and services the business center offers to its clients. Amenities and equipment such as computers, projectors, video conference equipment, special chairs or furniture, as well as services such as copying, package handling and shipping (for example, FedEx), concierge services, and the like. Reserving, scheduling and billing these services is a critical part of efficiently running a business center. Current reservation and management systems to not integrate these functions and do not allow a reservation system to provide an independent business center with the critical insight and control of their facilities, amenities and services.

Accordingly, a need exists to provide an efficient and automated booking and payment system.

### BRIEF DESCRIPTION OF THE FIGURES

FIG. 1 is a generalized block diagram of a computer system that may be used to implement the present invention.

FIG. 2 is a generalized block diagram of a computer system that may be used to implement the business center portal.

FIG. 3 is a generalized block diagram of a server computer that may be used to implement the present invention.

FIG. 4 is a generalized block diagram of a business center portal page displaying available business center facilities, according to one embodiment of the invention.

FIG. 5A is a generalized block diagram of a location selection page, according to one embodiment of the invention.

FIG. 5B is a generalized block diagram of an business center properties page, according to one embodiment of the invention.

FIG. 6 is a generalized block diagram of an office date selection page, according to one embodiment of the invention.

FIG. 7 is a generalized block diagram of a conference room date and time-slot selection page, according to one embodiment of the invention.

FIG. 8 is a generalized block diagram of an available property listing page, according to one embodiment of the invention.

FIG. 9 is a generalized block diagram of the selection page, according to one embodiment of the invention.

FIG. 10 is a generalized flow diagram of the process of updating the inventory database, according to one embodiment of the present invention.

FIG. 11 is a generalized flow diagram of the process of selecting a business center facilities resource, according to one embodiment of the present invention.

FIG. 12 is a generalized block diagram of the affiliate maintenance page, according to one embodiment of the invention.

FIG. 13 is a generalized block diagram of the plan maintenance page, according to one embodiment of the invention.

FIG. 14 is a generalized block diagram of the recurring fee maintenance page, according to one embodiment of the invention.

FIG. 15 is a generalized block diagram of the plan maintenance page, according to one embodiment of the invention.

FIG. 16 is a generalized block diagram of the client move in, move out page, according to one embodiment of the invention.

FIG. 17A is a generalized block diagram of the client conference room reservation date selection page, according to one embodiment of the invention.

FIG. 17B is a generalized block diagram of the client conference room reservation page, according to one embodiment of the invention.

FIG. 18 is a generalized block diagram of the occupancy report page, according to one embodiment of the invention.

FIG. 19 is a generalized block diagram of the room availability report page, according to one embodiment of the invention.

FIG. 20 is a generalized block diagram of the equipment selection page, according to one embodiment of the invention.

FIG. 21 is a generalized block diagram of the equipment availability report page, according to one embodiment of the invention.

FIG. 22 is a generalized block diagram of the service selection page, according to one embodiment of the invention.

FIG. 23 is a generalized block diagram of the service schedule report page, according to one embodiment of the invention.

### SUMMARY

The present invention provides for a computer based system and method for presenting, searching and reserving business center facilities. Business center personnel may use the portal to manage their business center including receiving reports on facilities, equipment, and service availability, reports on business center tasks such as client move in or move out, schedule related tasks, and receive reports on the revenue and utilization of the business center according to various factors such as time, customer, location, and the like.

### RELATED APPLICATIONS

The present application is a continuation-in-part of U.S. patent application entitled “Method and System of Managing an Online Reservation System for a Business Center” filed Jul. 18, 2004.

### DETAILED DESCRIPTION

The present invention is described in the context of a specific embodiment. This is done to facilitate the understanding of the features and principles of the present invention and the present invention is not limited to this embodiment. In particular, the present invention is described in the context of a web site for displaying and booking business center facilities.

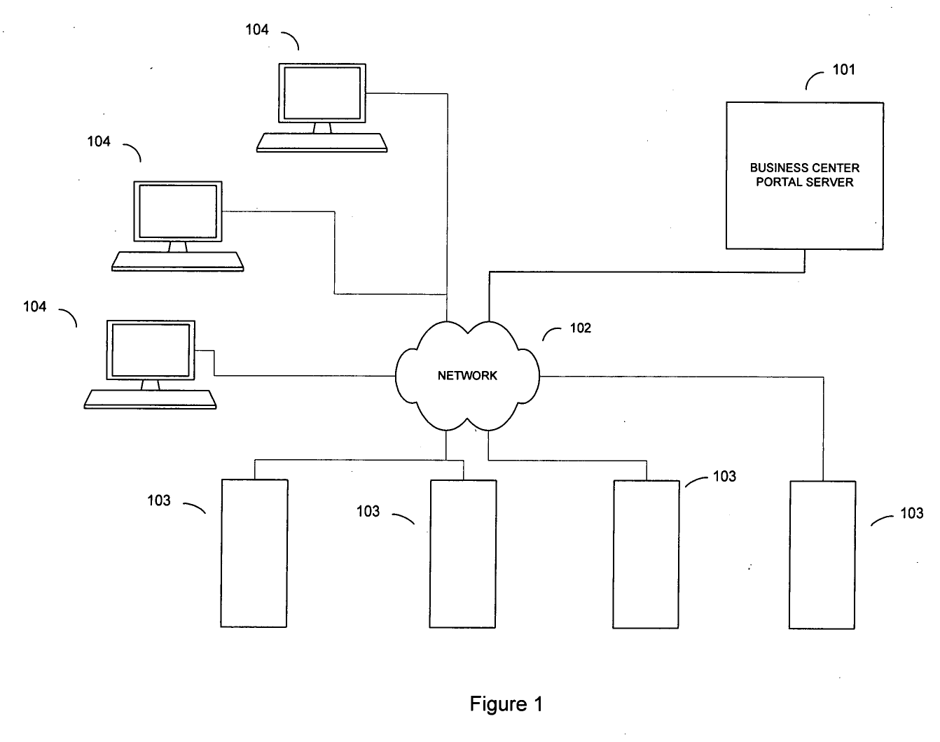

FIG. 1 is a block diagram of a computer system 100 that may be used to implement embodiments of the present invention. A business center portal server 101 is connected to a communications network 102. Business center servers 103 are connected to the business center portal server through communications network 102. End-user communication devices 104 are connected to the business center portal server through the communications network 102. The business center servers are the servers used to manage the inventory and/or sales of a given business center. Typically, each business center maintains its own inventory of available facilities resources which is available on the business center server.

In the presently preferred embodiment, the end-user communications device is a personal computer. Additionally, in the presently preferred embodiment the communications network is the Internet. Connection to the Internet could be by any form of Internet connection, including broadband and wireless connection. Alternatively, a private network or direct link could be established between the business center portal server and the business center servers. Alternatively, the end user communications device could be a mobile phone (including web enabled mobile phones or mobile phones with text messaging capabilities), standard telephone, or any other device capable of receiving text or voice messages.

The business center portal server could be implemented on one single server or on multiple servers. As used in the present application, the term server may refer to a physical computer or to software performing the functions of a server.

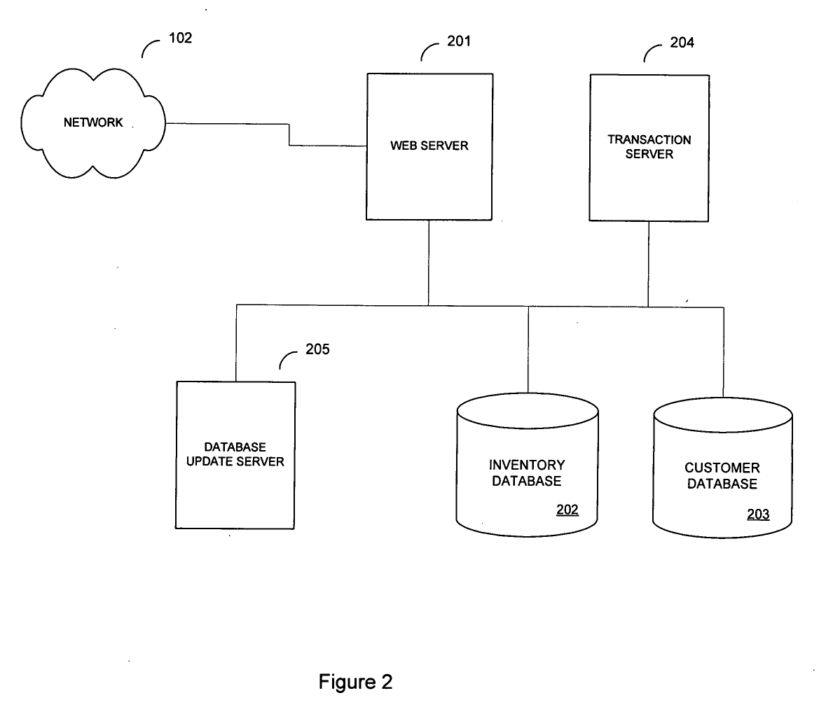

FIG. 2 is a generalized block diagram of the business center portal server shown in FIG. 1. A web server 201 provides web pages describing the business center facilities and services available through a communication network 102. The web server is connected to a business center inventory database 202, a customer database 203, a transaction server 204 and a database update server 205. The business center inventory database 202 stores information on the facilities, facilities resources, equipment, amenities and services offered by the various business centers through the business center portal. The transaction server 203 allows potential customers to reserve facilities and order services. The customer database server 204 stores information relating to customers and the services and facilities they have requested or purchased. The database update server 205 updates the business center inventory database from the business center servers and provides update information to the business center servers.

While the presently preferred embodiment utilizes an inventory database as a separate database from the customer database, alternate embodiments could have utilize one database for both inventory and customer information. Additionally, the information stored within any single database of the presently preferred embodiment could be distributed among several databases in alternative embodiments.

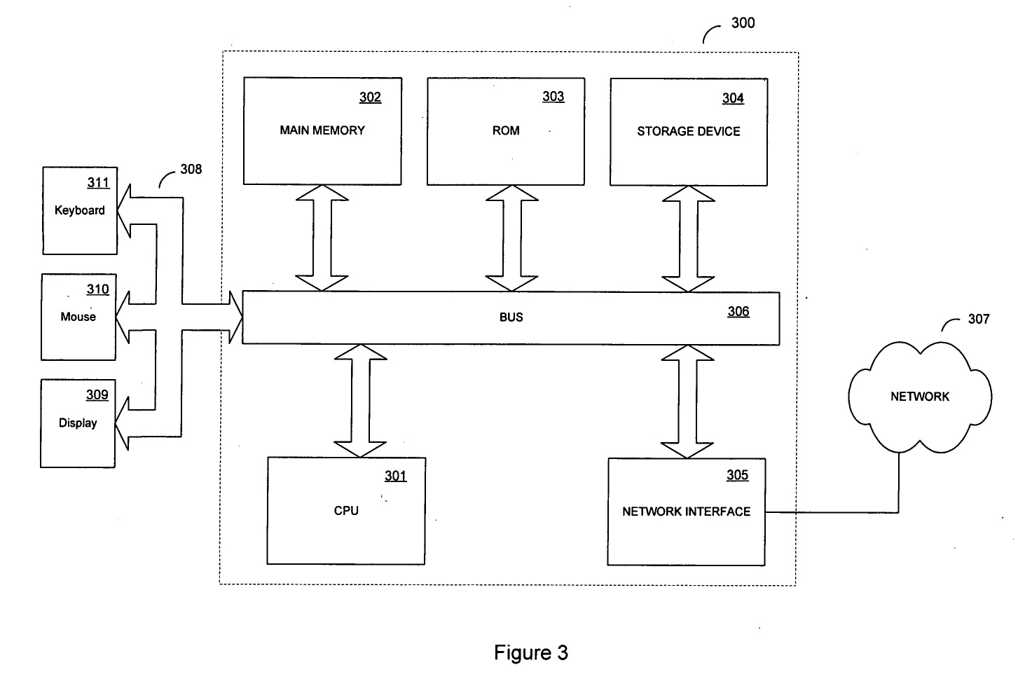

FIG. 3 is a generalized block diagram of a business center portal server computer 300 including a central processing unit (CPU) 301, main memory (typically RAM) 302, read-only memory (ROM) 303, a storage device (typically a hard drive) 304, and a network device (typically a network interface card, a.k.a. NIC) 305. The network device connects to a communications network 307. The server includes a bus 306 or other communication mechanism for communicating information between the CPU 301 coupled with bus 306. The CPU 301 is used for processing instructions and data. The main memory 302, ROM 303 and storage device 304 are coupled to bus 306 and store information and instructions to be executed by processor 301. Main memory 302 also may be used for storing temporary variables or other intermediate information during execution of instructions to be executed by processor 301.

Server 300 may be coupled via bus 308 to a display 309, such as a cathode ray tube (CRT) or flat panel monitor, for displaying information to a computer user. An input device 310, such as a keyboard, is coupled to bus 308 for entering information and instructions to the server 300. Additionally, a user input device 311 such as a mouse, a trackball, or cursor direction keys for communicating direction information and command selections to the processor 301 and for controlling cursor movement on the display 309 may be used with the server 300.

The server 300 is designed to run programs implementing methods, such as the methods of the present invention. Typically such programs are stored on the hard drive of the server, and instructions and data of the program are loaded into the RAM during operation of the program. Alternate embodiments of the present invention could have the program loaded into ROM memory, loaded exclusively into RAM memory, or could be hard wired as part of the design of the server. Accordingly, programs implementing the methods of the present invention could be stored on any computer readable medium coupled to the server. The present invention is not limited to any specific combination of hardware circuitry and software, and embodiments of the present invention may be implemented on many different combinations of hardware and software.

As used within the present application, the term “computer-readable medium” refers to any medium that participates in providing instructions to CPU 301 for execution. Such a medium may take many forms including, but not limited to, non-volatile media, volatile media, and transmission media. Examples of non-volatile media include, for example, optical or magnetic disks, such as storage device 304. Examples of volatile media include dynamic memory, such as main memory 302. Additional examples of computer-readable media include, for example, floppy disks, hard drive disks, magnetic tape, or any other magnetic medium, a CD-ROM, any other optical medium, punchcards or any other physical medium with patterns of holes, a RAM, a PROM, and EPROM, a FLASH-EPROM, any other memory chip, stick or cartridge, a carrier wave as described hereinafter, or any other medium from which a computer can read. Transmission media includes coaxial cables, copper wire and fiber optics, including the wires that comprise bus 306 and 308. Transmission media can also take the form of acoustic, electromagnetic or light waves, such as those generated during radio-wave and infra-red data communications.

The business center server and end user communication device are similar in general architecture to the business center portal server.

### Presenting and Selecting Business Center Inventory

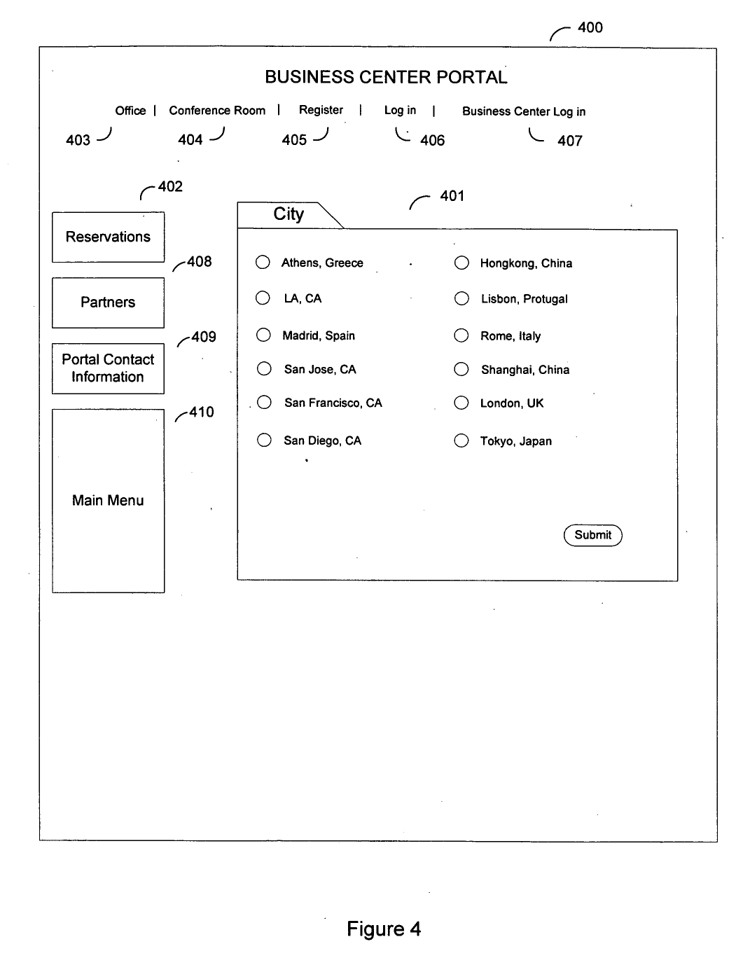

The present invention provides a web accessible portal for visitors to search for, view, reserve and book business center facilities resources, such as offices and conference rooms. FIGS. 4-9 illustrate the business center facilities resource selection and booking aspect of the present invention. In the presently preferred embodiment, the pages shown in these figures are accessible to a potential customer over the Internet using a web browser.

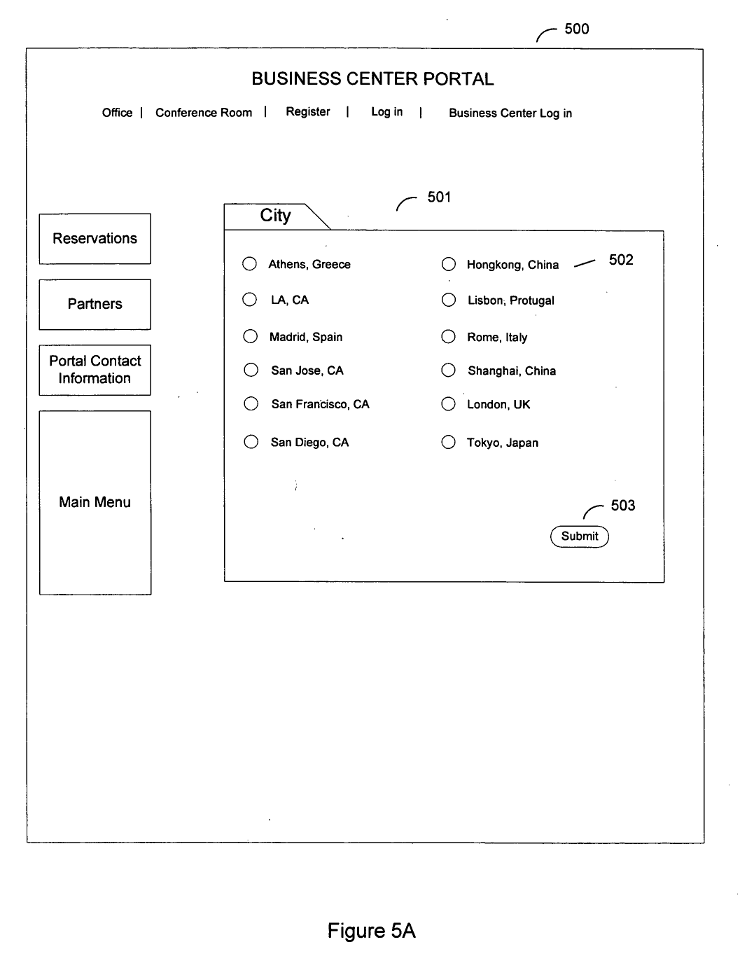

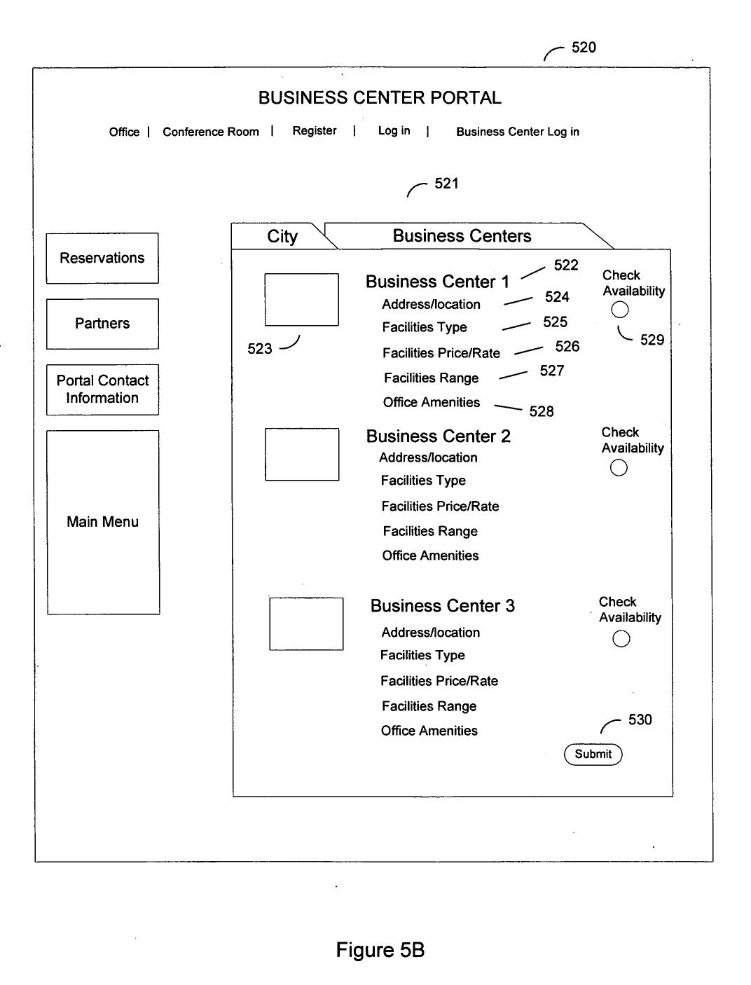

FIG. 4 is a generalized block diagram of a business center portal page 400. A location selector 401 allows visitors to move to a specific region or location. The location selector is described in connection with FIG. 5A. A reservations link 402 allows a visitor to connect to a reservations page which display's the visitor's current reservations. An office link 403 allows a visitor to view an office properties page 520 shown in FIG. 5B. While location indicators 502 are text indicators, alternate embodiments of the present invention may use graphical indicators depicting a symbol or map. A conference link 404 allows a visitor to view a conference facilities page 520 shown in FIG. 5B. A log in link 405 takes a visitor to a sign in page where the visitor can enter their username and password to allow them to view specific information particular to that visitor. A register link 406 takes a visitor to a registration page where the visitor can create a personal account with a username and password. A business center log in link 407 connects a visitor with business center management page.

Additionally, page 400 also includes a partner link 408 which connects to partners of the business center portal, a contact link 409 which takes a visitor to a page displaying contact information for the business center portal, and a menu 410 which has links to several pages within the portal. As described, business center portal page 400 has several links common to several pages of the present invention.

FIG. 5A is a generalized block diagram of the location selection page 500. A location selector 501 allows visitors to move to a specific region or location. Locations where business center facilities are available are presented at the location indicators 502. In the presently preferred embodiment the locations are cities where there is a business center. Alternatively, the location indicators may identify countries, states or provinces, regions, neighborhoods or any other geographic location. In the presently preferred embodiment, by selecting a location the visitor is taken to the office properties page 520 shown in FIG. 5B. Optionally, once the visitor has made their sections of dates and number of persons the visitor may hit enter or click the submit button 503 to be taken to the office properties page 520.

FIG. 5B is a generalized block diagram of the office properties page 520. The properties according to a given criteria, for example in a specific region as selected on page 500 described above, are shown in a business center property list 521. Property identifier fields 522 identify the business centers. The business centers located on the page could include all the business centers available through the portal, or a subset of the business centers available. The subset of available business centers displayed on the properties page could be based on geographic area, type of facility, services available, quality level, price level, length of time available, minimum contract length, ownership or affiliation, or other aspects of the property or service provided by the business center.

In the presently preferred embodiment, the business center properties page also includes property image 523, property location 524, facilities type 525, facilities rate (or price) 526, and facilities amenities 527. The property location indicator can either be a textual indicator, indicating a city, town, region, neighborhood, district or street address, or it could be graphical, representing location information in a map or symbol form. The facilities type indicator provides information on the type of building, such as an office tower or high rise, executive office park, office park, strip mall, mixed live/work, or other type of facility. A visitor to the business center portal may check on the availability of a particular property by selecting the Check Availability button 529, which will take the visitor to the date selection page 600 described below.

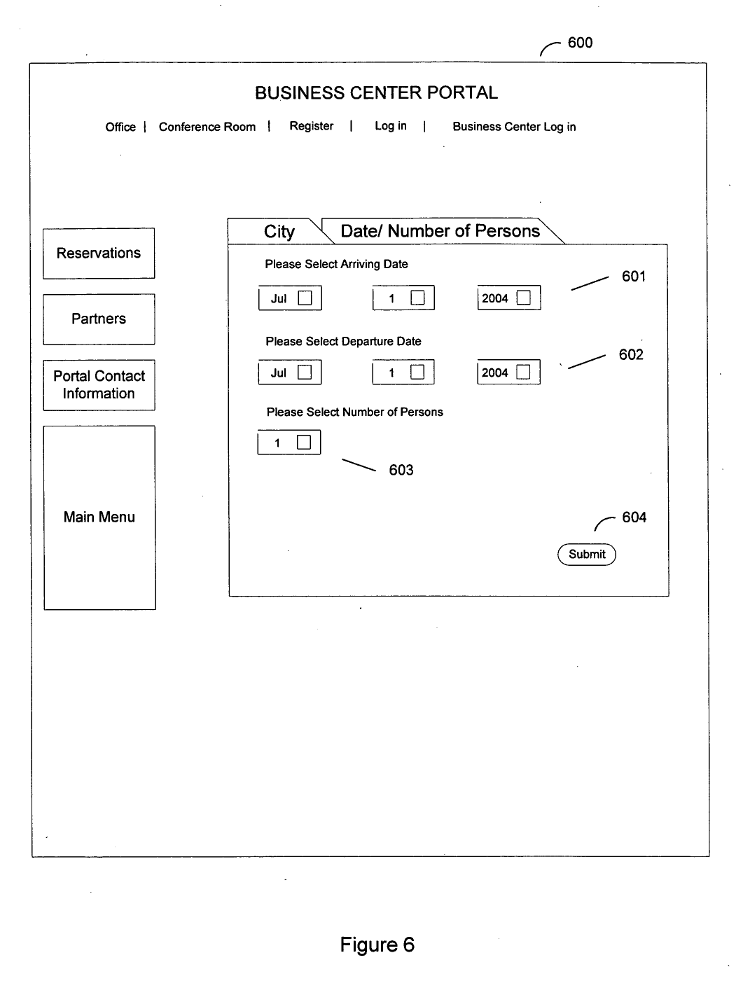

FIG. 6 is a generalized block diagram of an office date selection page 600. An arriving date selector 601 allows visitors to select the date they would first need an office at a business center. A departure date selector 602 allows visitors to select the date they would last such an office. The arriving date selector and departure date selector are in the form of a month, day, day year selector. Additionally, the date selector may include the arriving time and ending time for the visitor. Alternative designations could be sued such as a calendar selector, where the visitor selects a date from a calendar, or any other form of representing the date or time. In the presently preferred embodiment the date selection page 600 also includes a number of persons selector 603 where the visitor may specify the number of people who would need offices a the business center. Once the visitor has made their sections of dates and number of persons the visitor may hit enter or click the submit button 604.

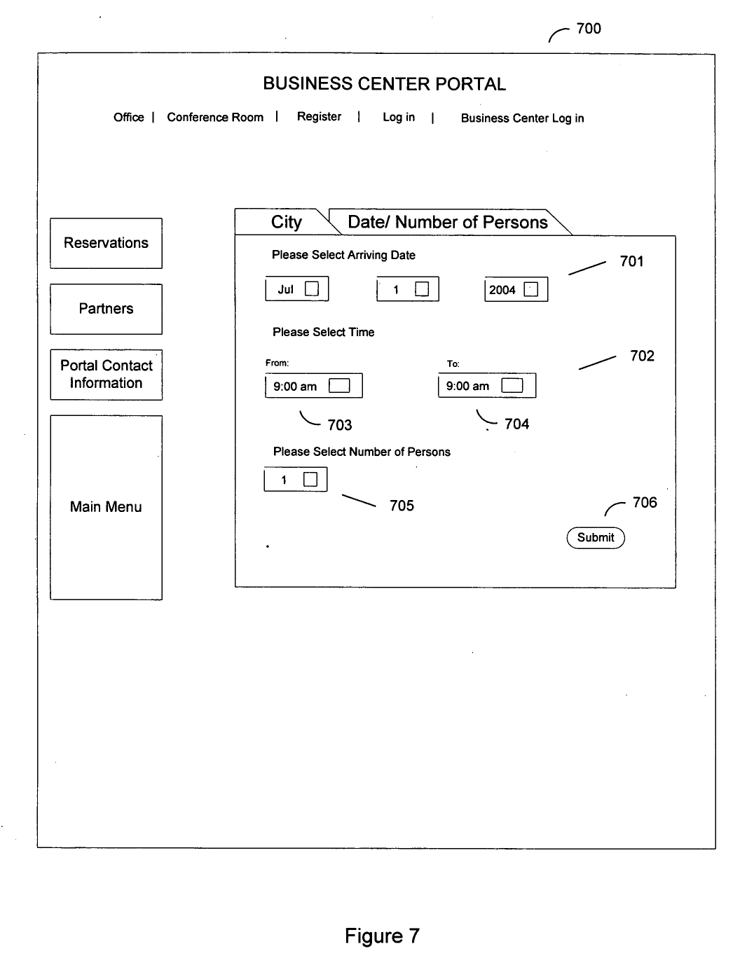

FIG. 7 is a generalized block diagram of a conference room date and time-slot selection page 700. A date selector 701 allows visitors to select the date they would need a conference room at a business center. A time slot selector 702 allows visitors to select the time-slot they would need a conference room. The time-slot selector 702 includes a start time selector 703 where a visitor may specify the start time for the conference room reservation. The time-slot selector 702 also includes a start time selector 704 where a visitor may specify the end time for the conference room reservation. In the presently preferred embodiment the conference room date selection page 700 also includes a number of persons selector 705 where the visitor may specify the number of people the conference room would need to accommodate. Once the visitor has made their sections of dates and number of persons the visitor may hit enter or click the submit button 706.

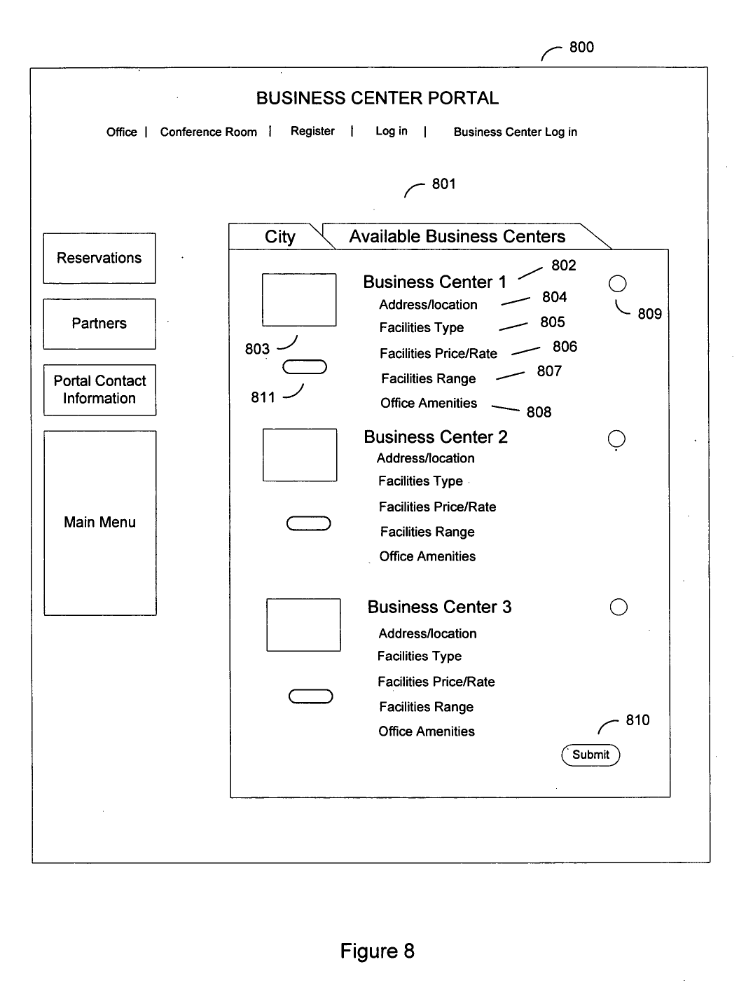

Once the date and time-slot selection query is entered from either the office date selection page 600 or conference room date and time-slot selection page 700 the business center portal system returns a list of available properties as shown in FIG. 8.

FIG. 8 is a generalized block diagram of an available property listing page 800. The property listing page 800 includes a list of properties returned from the search for available properties. In the presently preferred embodiment, the properties returned meet all of the criteria specified in the prior selection page. Alternatively, the returned results may meet a subset of the specified criteria, or may represent a closest relevant fit to the specified criteria.

The visitor may view the properties returned as well as compare and contrast the available offices or conference rooms. In the presently preferred embodiment, the properties returned are listed and displayed with the property name indicator 802, property image 803, property location 804, facilities type 805, facilities rate (or price) 806, facilities range 807, facilities amenities 808, and business center rating indicator 811. The property location indicator can either be a textual indicator, indicating a city, town, region, neighborhood, district or street address, or it could be graphical, representing location information in a map or symbol form. The facilities type indicator provides information on the type of building, such as an office tower or high rise, executive office park, office park, strip mall, mixed live/work, or other type of facility.

When a business center has more than one type of facilities resource the property listing page may include indicators 807 for the range of facilities resource types. For example, some business centers offer premium executive offices, standard offices, junior offices, and office suits within the same facility. As another example of the range of facilities resources, some business centers offer small conference rooms, large conference rooms, meeting rooms, or other types of meeting facilities. The facilities range indicator may specify the different types of facilities resources available.

The amenities indicator indicates the type of amenities or services available at the business center. Examples of amenities and services include phone answering services, package handling services, secretarial or word processing services, video conference services, or any other type of service or amenity offered by business centers.

The business center rating indicator 811 provides a quality rating of the business center. For example, some facilities are rated according to stars, such as three starts or four stars, based upon the quality of the facility.

Once the visitor decides which business center they would like to rent an office (or conference room) from the visitor may select that business center and be taken to the office selection page 900.

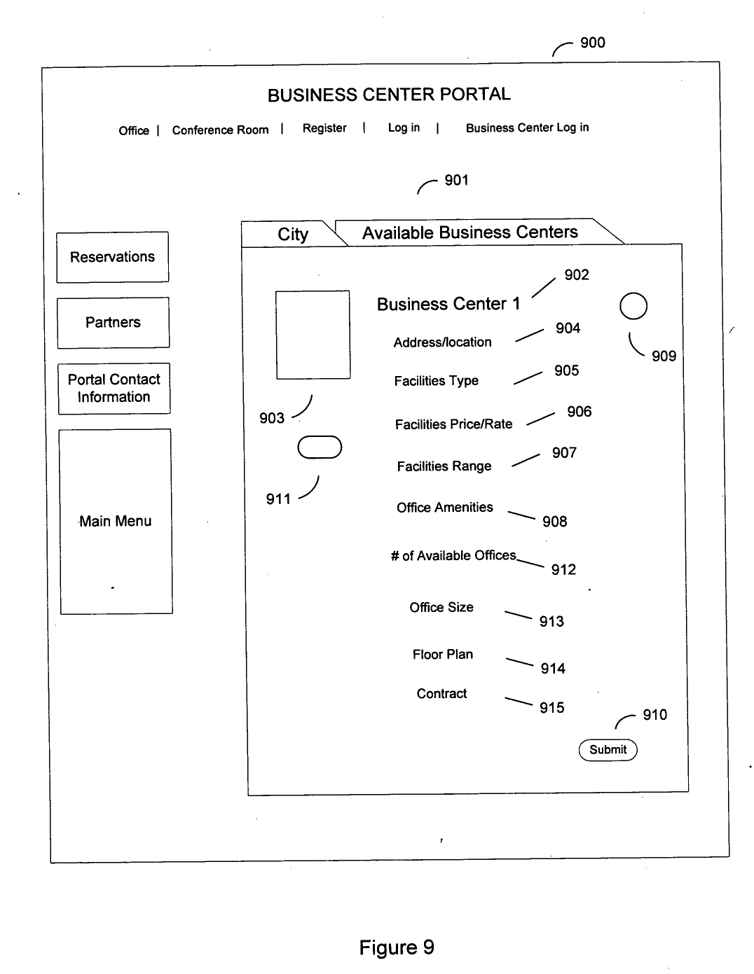

FIG. 9 is a generalized block diagram of the selection page 900. The selection page 900 gives the visitor additional details of the business center and office or conference room selected at the property listing page 800 shown above.

In addition to the information shown on page 900, such as the property name indicator 902, property image 903, property location 904, facilities type 905, facilities rate (or price) 906, facilities amenities 907, and business center rating indicator 911, the selection page 900 includes the number of available offices 912, the size of the office (or size range of the different types of offices) 913, the floor plan 914, and the types of available contracts 915. The types of available contracts 915 may include term contracts, such as hourly, daily or monthly, contract minimum commitments, for example 3 hour minimum for an hourly contract, deposit requirements, or other aspects or terms of the contract to book a business center facilities resource.

The visitor may book the business center facilities resource by clicking on the booking button 910.

### Updating Business Center Portal Inventory

The present invention provides the access to available inventory in “real time” by synchronizing the inventory of the portal and the business centers. Business centers have the option of manually entering their inventory to the business center portal, or they may have the business center portal obtain inventory updates from the business center server.

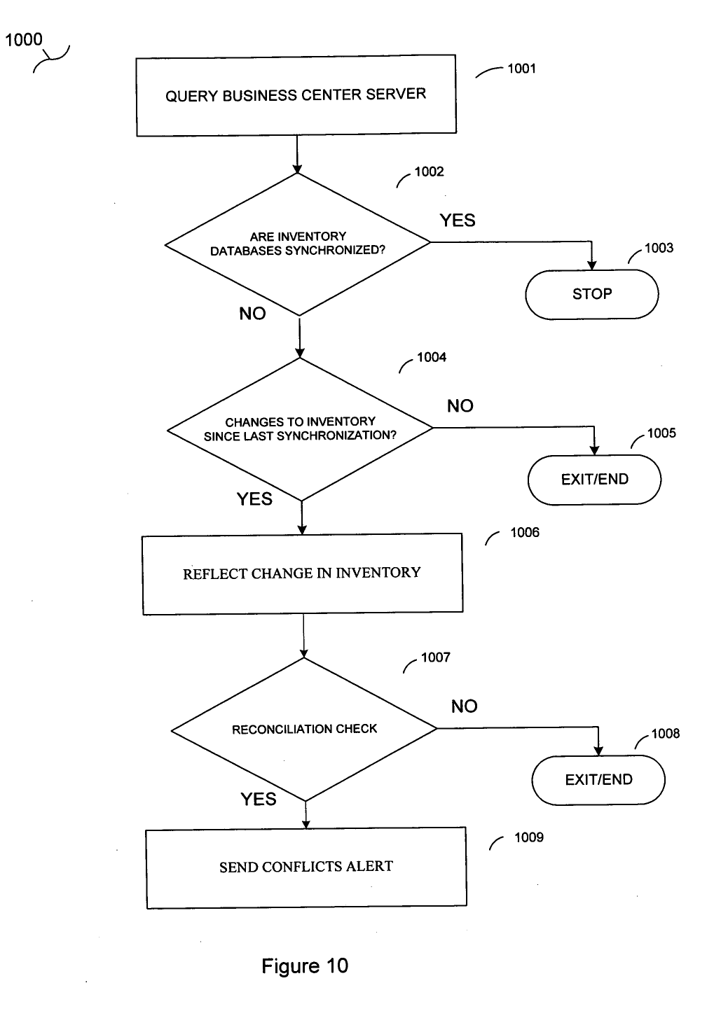

FIG. 10 is a generalized flow diagram of the process 1000 of updating the inventory database. According to the presently preferred embodiment, the business center portal queries the business center servers at step 1001 to determine whether the inventory in the business center's server is synchronized with the inventory of the business center portal, contained in the inventory database. At step 1002 the business center portal determines whether the two inventories are synchronized. If at step 1002 the system determines they are synchronized, then process 1000 proceeds to step 1003 and the synchronization ends. If at step 1002 the system determines the inventories are not synchronized, then the system proceeds with synchronization and advances to step 1004.

At step 1004 the system compares the two inventories to determine if the business center has added or removed inventory since the last synchronization. If at step 1004 the system determines the business center bas not changed its inventory or its availability, and that the business center portal has not changed the availability of the business center's inventory, the system proceeds to step 1005 and the synchronization process is stopped.

If at step 1004 the system determines the business center has added or removed inventory since the last synchronization the system proceeds to step 1006 where the changes in the business centers inventory is reflected in the inventory database of the business center portal. If the business center removed inventory, for example when the business center booked an office or a conference room, at step 1006 the system will remove these booked facilities resources as available from the inventory database of the business center portal. If the business center has added inventory, for example when a booking is cancelled or additional facilities are added during an expansion, then at step 1005 the system will add these facilities resources as available in the inventory database of the business center portal.

If at step 1004 the system determines the business center portal has added or removed inventory since the last synchronization the system proceeds to step 1006 where the changes in the business center portal's inventory is reflected in the business center server. If the business center portal removed inventory, for example when the business center portal booked an office or a conference room, at step 1006 the system will remove these booked facilities resources as available from the business center server. If the business center portal has added inventory, for example when a booking is cancelled or a tenant moves out early, then at step 1006 the system will add these facilities resources as available in the business center server.

After step 1006 the system proceeds to step 1007 where a reconciliation check is performed. Depending upon the frequency of synchronizations between the business center portal and the business center server, there exists the possibility that the business center portal and business center may make conflicting changes to the availability of a facilities resource, for example when the business center and portal both book the same office for a given day. At step 1007 the system checks for such conflicts and in the event of a conflict sends a conflicts message at step 1009 to the management of the portal and the effected business center indicating the details of the conflict. If no conflict is detected at step 1007 the system proceeds to step 1008 where the synchronization process ends.

While the current embodiment performs the conflicts check at the end of the synchronization process, alternate embodiments could perform the check before the two inventories are synchronized.

An alternate embodiment of the present invention allows business center management to use the portal as their own inventory management system. In this embodiment the business center management make direct changes to the business center portal inventory database. For example, when business center management book a facility, as is done with brokers, the management (or the broker) may log in to the business center portal and enter the booking, thereby removing the facilities resource from the list of available resources for the given time period.

### Selecting and Booking Business Center Inventory

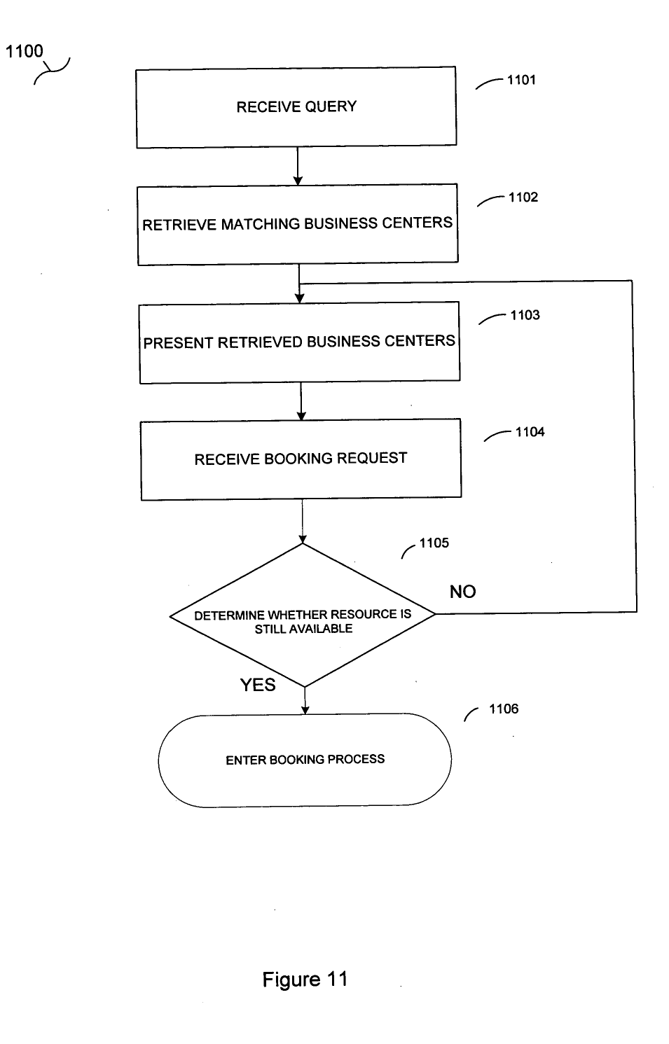

FIG. 11 is a generalized flow diagram of the process 1100 of selecting and booking a business center facilities resource using the business center portal described in connection with FIGS. 4 though 9. At step 1101 the system receives a query from an end user communication device. The query may specify the geographic area, the type of facility, as well as particulars relating to time, price or other aspects of business centers. At step 1102 the system retrieves the available business center facilities resources matching the query parameters from the inventory database of the business center portal. At step 1103 the system presents the results retrieved form the inventory database. In the presently preferred embodiment, the results are presenting by sending a web page to the end user communication device. The potential consumer may do additional searching, submitting additional queries, may ask for more information on a particular business center or business center facilities resource. The present invention will receive and respond to such queries as described in connection with steps 1101 through 1103. Once they decide to book a resource the customer clicks a book button which sends a book request to the business center portal. At step 1104 the business center portal receives a booking request. At step 1105 the system checks that the resource has not already become unavailable while the consumer was viewing search results. If at step 1105 the system determines the resource is no longer available the system presents an update to the end user communication device at step 1103 indicating the latest state of the inventory, where the consumer may select and book from the available resources. If at step 1105 the system determines the resource is still available the system updates the inventory database to reflect the resource as booked, to prevent other consumers also viewing available properties from simultaneously booking that resource.

After the inventory database update step 1105, the system proceeds to step 1106 where the system enters a reservation and booking process. The reservation and booking process may include paying for, or putting a deposit down on the reservation. In the presently preferred embodiment the booking process may only be accomplished when the consumer is logged into the system. However, alternate embodiments of the present invention could allow booking without the consumer being logged into the system. In such and embodiment the reservation and booking process may include collecting information on the consumer, and the reservation and booking process may occur prior to the inventory database update step.

### Managing Business Center Inventory

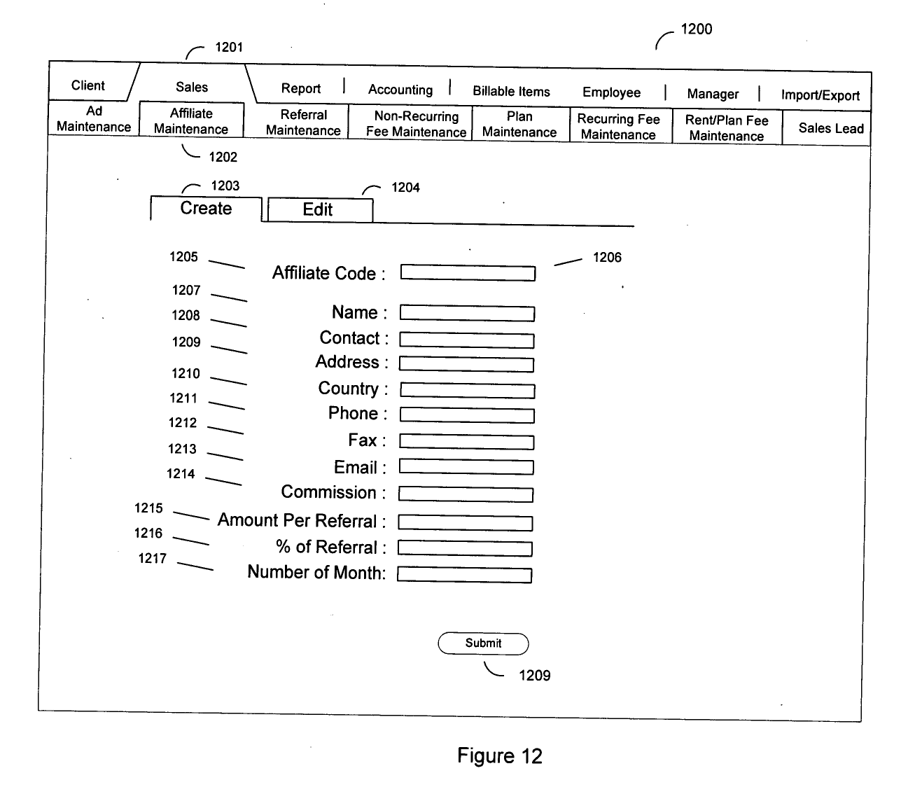

The present invention provides for the management of business center sales, inventory, facilities, and employees. As described in FIGS. 12-19, managers or employees may log into the portal to manage the various aspects of their business center.

FIG. 12 is a generalized block diagram of an affiliate maintenance page 1200. The affiliate maintenance page is contained within the sales section of the portal and provides business center managers or employees the ability to create, edit and manage the affiliate relationships. For example, a business center may be affiliated with another business center (or other entity) and will provide referral fees for business center facilities resources or amenities that are purchased from a referral from the affiliate.

Business center personnel may reach the affiliate maintenance page 1200 by clicking on the sales tab 1201, and the affiliate maintenance tab 1202 which is displayed when the sales tab is selected. Personnel may select the create tab 1203 or the edit tab 1204 to, respectively create or modify an entry for an affiliate. The affiliate create and modify fields include an affiliate code 1206 for identifying the affiliate, an name for the affiliate 1207, a contact person for the affiliate 1208, an address for the affiliate 1209, a country for the affiliate 1210, a phone number for the affiliate 1211, a fax number for the affiliate 1212, an email address for the affiliate 1213, a commission for the affiliate 1214, an amount per referral for the affiliate 1215, a percentage of referral for the affiliate 1216, and a number of month 1217. An associated entry field 1206 is available to receive information, either as entered or modified text, selection from a list, or other ways of entering or modifying information. Once the plan information has been entered or modified the information is stored in the system by selecting the submit button 1218.

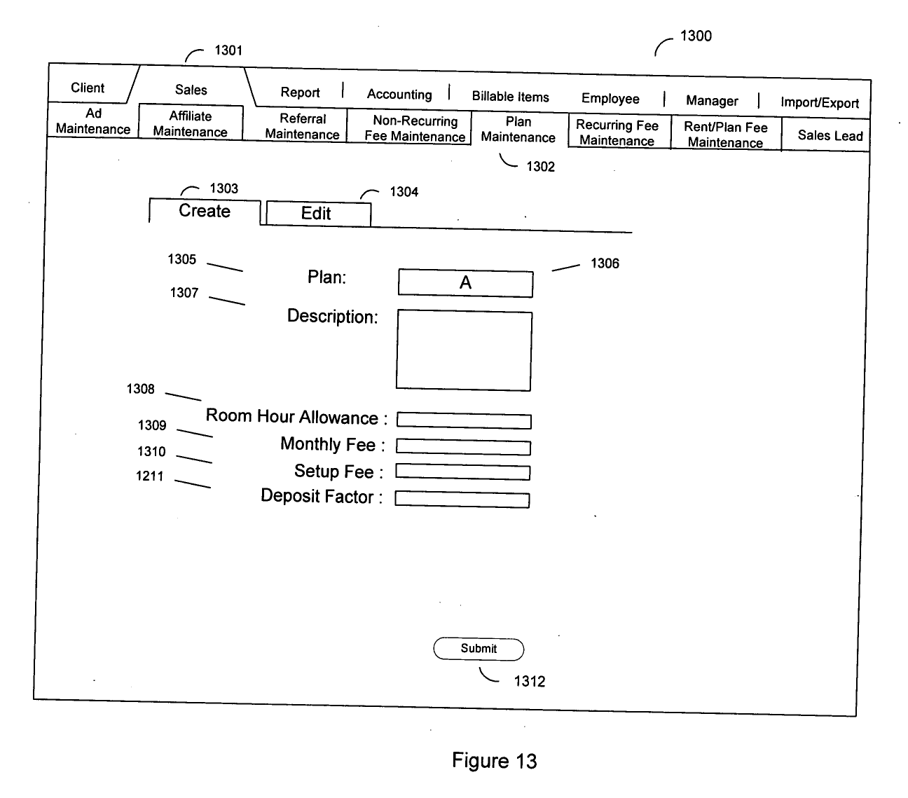

FIG. 13 is a generalized block diagram of a plan maintenance page 1300. Business center personnel may create or modify details of offices, conference rooms, or other business center facilities resources as a group by modifying a plan, and all business center facilities resources associated with that plan will be created or modified accordingly.

Business center personnel may reach the plan maintenance page 1300 by clicking on the sales tab 1301, and the plan maintenance tab 1302 which is displayed when the sales tab is selected. Personnel may select the create tab 1303 or the edit tab 1304 to, respectively create or modify an entry for a business center facilities resource plan. The business center facilities resource plan create and modify fields include the plan designator 1305, the plan description 1306, the room hour allowance 1307, the room monthly fee 1308, the room setup fee 1309, and the room deposit facto 1310. An associated entry field 1306 is available to receive information, either as entered or modified text, selection from a list, or other ways of entering or modifying information. Once the plan information has been entered or modified the information is stored in the system by selecting the submit button 1312.

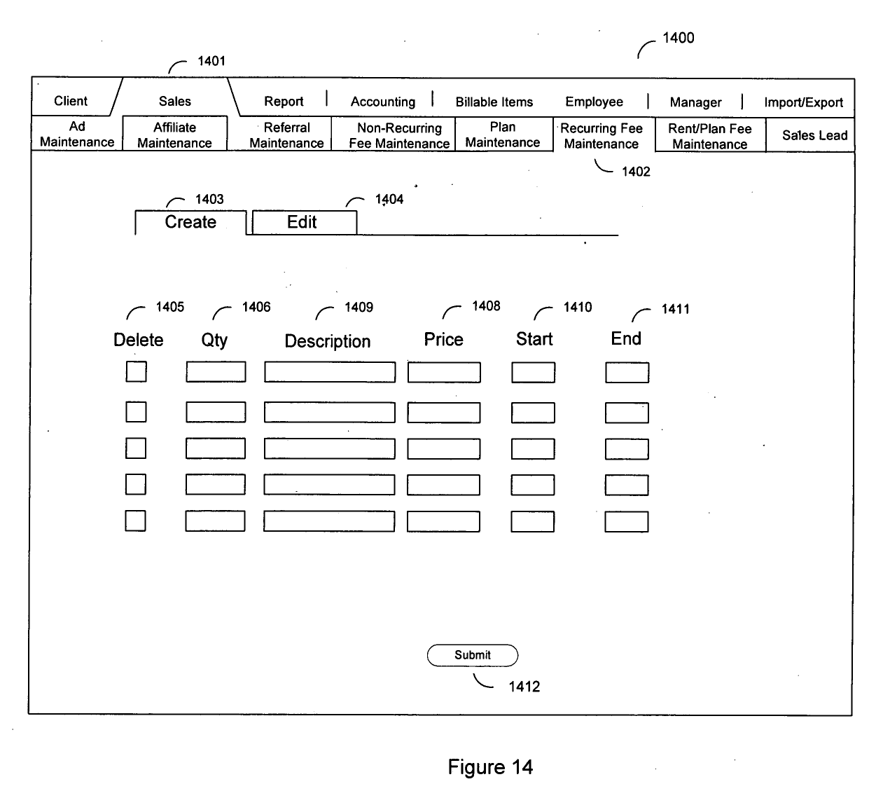

FIG. 14 is a generalized block diagram of a recurring fee maintenance page 1400. Business center personnel may create or modify details of recurring fees. Business center personnel may reach the recurring fee maintenance page 1400 by clicking on the sales tab 1401, and the recurring fee maintenance tab 1402 which is displayed when the sales tab is selected. Personnel may select the create tab 1403 or the edit tab 1404 to, respectively create or modify an entry for recurring fee. The recurring fee create and modify fields include the quantity 1406, the description of the item or service 1407, the price 1408, the start date or time 1410, and the end date or time 1411. Examples of descriptions, without limitation, include furniture, fax machines, computers, secretarial service, notary service, messenger service, high speed internet service/usage, and copier usage.

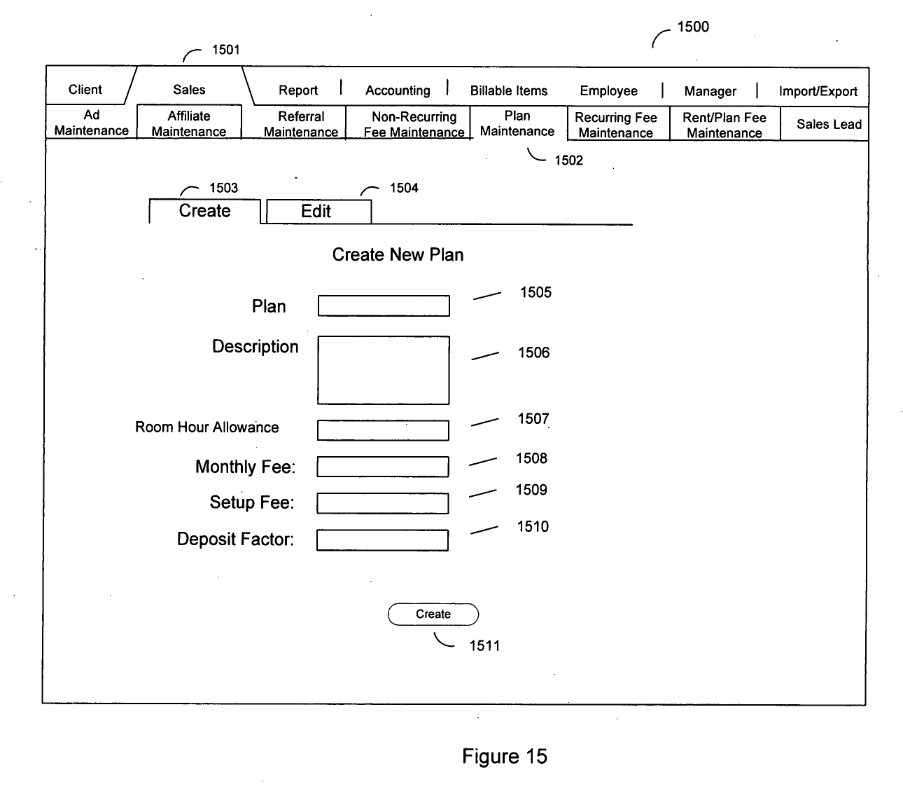

FIG. 15 is a generalized block diagram of the plan maintenance page 1500. Business center personnel may view, create or modify details of business center facilities resource plans. Business centers often use a plan to define a particular type of room having certain characteristics. For example, one type of room is an executive office. Examples of other types of business center facilities resources are standard office, junior office, small conference room, large conference room, training room, etc. Using plan maintenance page 1500 business center personnel may manage their facilities by creating new plans or modifying existing plans. Business center personnel are able to change the details of the plans shown to visitors, and used internally by the portal and the business center, to effectuate changing the details of multiple rooms merely by changing one plan.

Business center personnel may reach the plan maintenance page 1500 by clicking on the sales tab 1501, and the plan maintenance tab 1502 which is displayed when the sales tab is selected. Personnel may select the create tab 1503 or the edit tab 1504 to, respectively create or modify an entry for recurring fee. By clicking either the create tab or the edit tab the visitor is provided the plan detail fields. The plan detail fields include the plan name 1505, the plan description 1506, the room hour allowance 1507, the monthly fee 1508, the setup fee 1509, and the deposit factor 1510. Once a business center personnel has created a new plan (or modified an existing plan) they can store the entry by clicking the create button 1511 (in the edit tab, the create button stores the changes to an existing plan).

In the presently preferred embodiment, the management and change pages only allow business center personnel to view, change and create facilities resources, services, equipment, inventory, pricing, customer and other information for their business center, or for business centers which have authorized them to make such changes (for example, if one business center allows an affiliate to make certain changes in their pricing as part of a shared management). In the presently preferred embodiment, this access to business center information in the business center portal is controlled through the login process. However, alternate embodiments of the present invention could allow other ways to control access and privileges to business center and customer information.

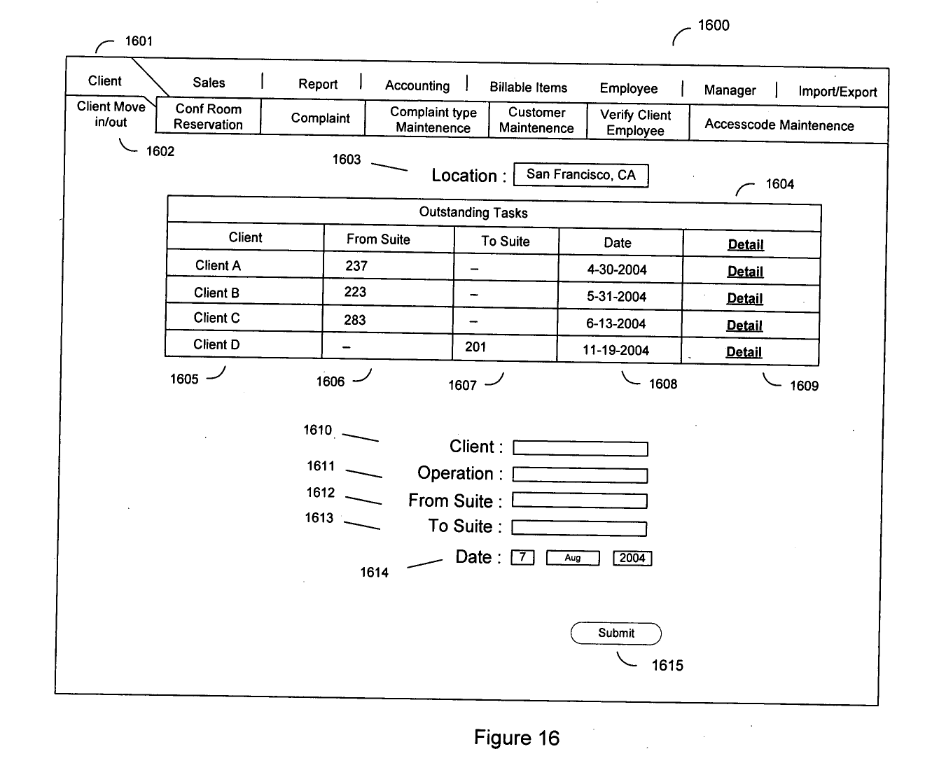

FIG. 16 is a generalized block diagram of the client move in, move out page 1600. Business center personnel may view, create or modify details of move in, move out details. The move in/move out details are also used by business center staff to plan work assignments such as preparing rooms for clients or cleaning and maintenance after a client has moved out.

Business center personnel may reach the client move in, move out page 1600 by clicking on the client tab 1601, and the plan the client move in, move out tab 1602 which is displayed when the client tab is selected. At the top of the page beneath the navigation bar is the business center's location identifier 1604. In the presently preferred embodiment, the location identifier is a drop down menu allowing business center personnel to select from the locations of that business center (and would not display the locations of belonging to other business centers). Below the location identifier is the outstanding tasks box 1604. The outstanding tasks box displays details of client moves and allows for the modification of the details of the move. The outstanding tasks box displays the pending moves and identifies the clients with the client identifier 1605. Additionally, the suite being moved from is shown with the from suite identifier 1606. The suite being moved to is shown with the to suite identifier 1607 the date of the move is shown in the move date field 1608. Additional details are displayed, or are available by following a link in the move details field 1609. Additional details may include instructions on the handling of a clients possessions or changes to the room to accommodate the new client, or return a room to a specific condition after a client has moved out.

Business center personnel may create additional move in or move out details and instructions using the move creation fields identifying the client 1610, the operation (move in or move out) 1611, from suite 1612, to suite 1613, and move date 1614.

Once the move information has been entered or modified the information is stored in the system by selecting the submit button 1615.

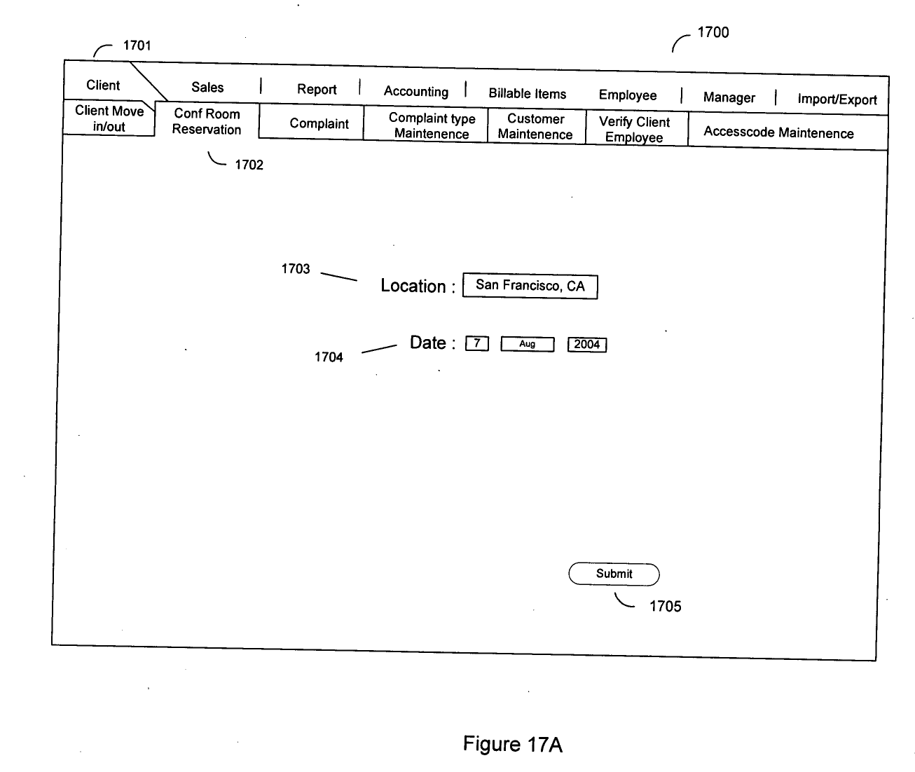

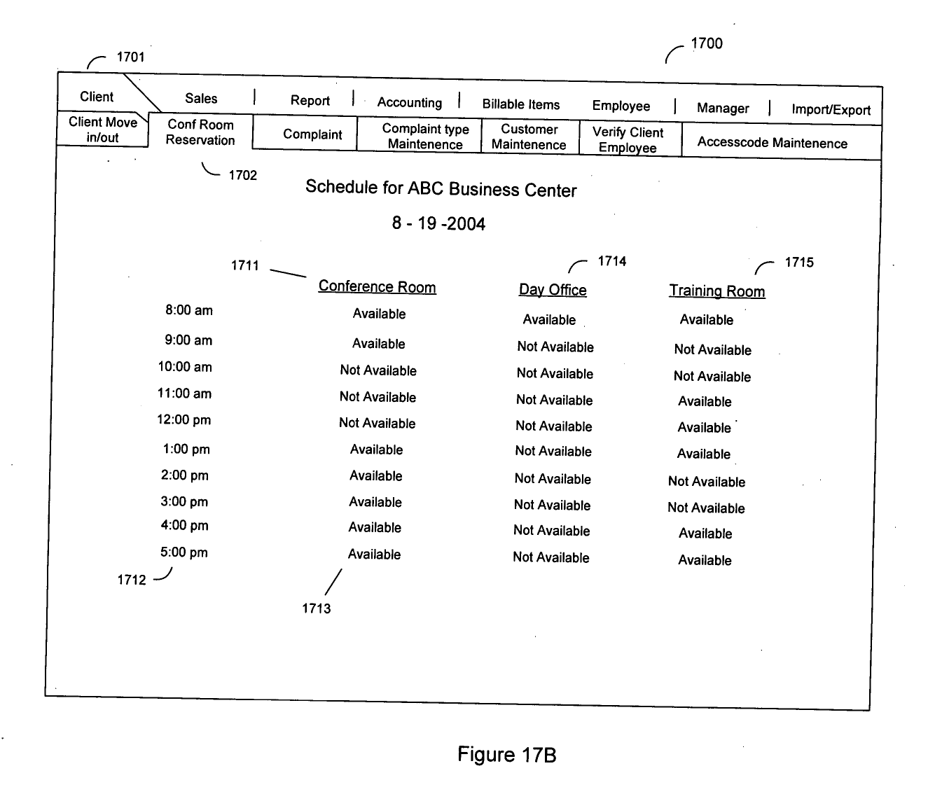

FIGS. 17A-7B illustrate the client conference room reservation pages. Business center personnel may view the conference room reservations by client, allowing business center personnel to assist clients in scheduling conference rooms, day offices, and training rooms.

FIG. 17A is a generalized block diagram of the client conference room reservation date selection page 1700.

Business center personnel may reach the client conference room reservation date selection page 1700 by clicking on the client tab 1701, and the conference room reservation tab 1702 which is displayed when the client tab is selected. At the top of the page beneath the navigation bar is the business center's location identifier 1703. Below the business center's location identifier is a date selector 1704. Once the location and date are entered the visitor retrieves the details of the conference room reservations by selecting the submit button 1705. After clicking on the submit button the visitor is taken to page 1710 shown in FIG. 17B.

FIG. 17B is a generalized block diagram of the client conference room reservation page 1710. The conference rooms and other facilities satisfying the entered criteria on page 1700 are displayed on page 1710. For example, a conference room indicator 1711 defines a column of entry fields where the status of the conference room reservation is indicated on a row. The time slot associated with the row is given by the time slot identifier 1712. The reservation status of the conference room as well as the other business center resource facilities listed on page 1710 is given by the reservation status identifier 1713. In the presently preferred embodiment the reservation status identifier indicates either available or not available as the status of the business center facilities resource.

A day office indicator 1714 defines a column of entry fields where the status of the day office reservation is indicated on a row. A training room indicator 1715 defines a column of entry fields where the status of the training room reservation is indicated on a row.

Business center personnel may change the status of any facilities resource reservation by clicking on the reservation status identifier 1713 where they will be taken to a page where they can either create a new reservation or edit an existing reservation, and then store this information in the system's database.

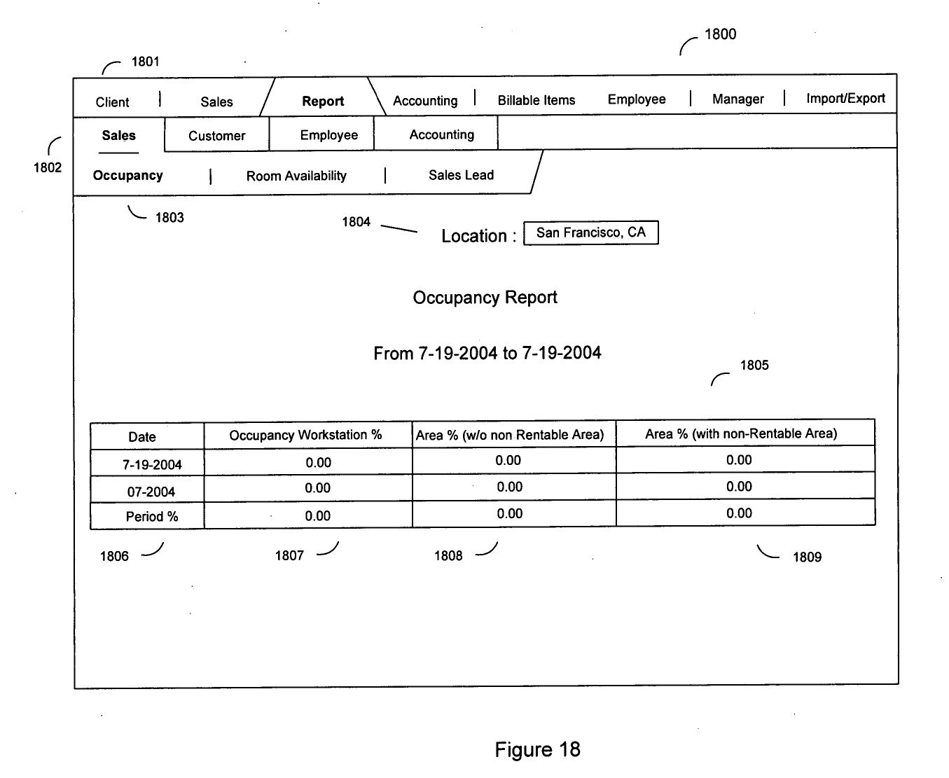

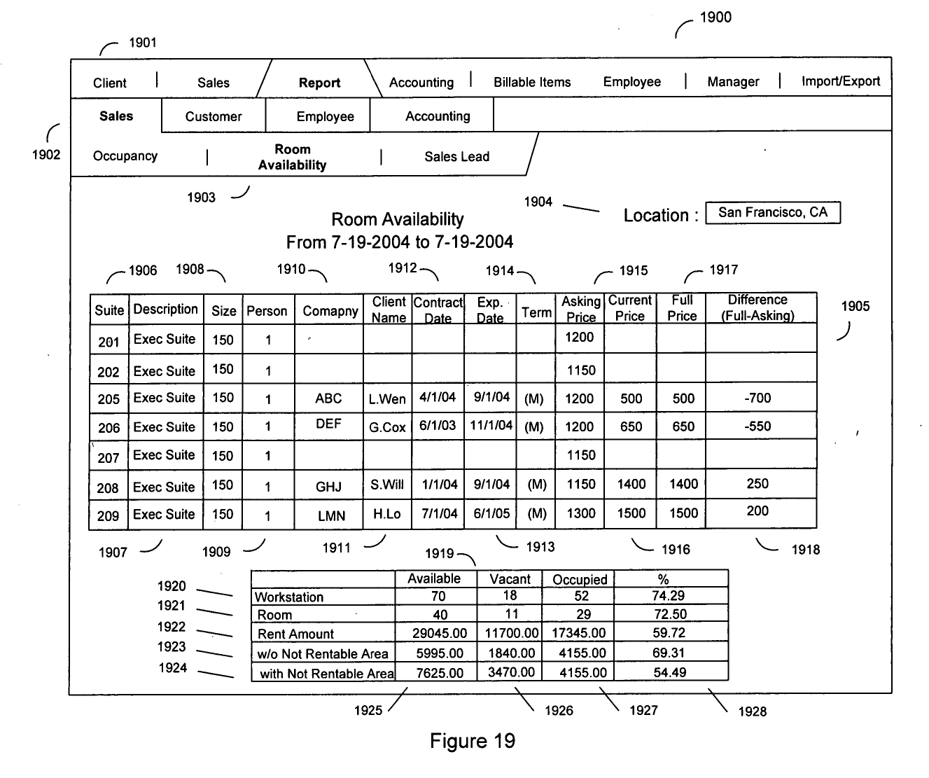

FIGS. 18-19 illustrate the report pages. Business center personnel may view the reservations, facilities resource availability, and generate reports by client, facility, resource type, resource availability as well as obtain reports on utilization.

FIG. 18 is a generalized block diagram of the occupancy report page 1800. Business center personnel may view details of the occupancy of the business centers, or group of business centers. The occupancy details are also used by business center staff to manage the business center including managing staffing, managing assigned tasks and work load, managing business center facilities pricing and special offers, managing promotional activities and advertising, and the like.

Business center personnel may reach the occupancy report page 1800 by clicking on the report tab 1801, and the sales tab 1802 which is displayed when the report tab is selected, and the occupancy tab 1803 which is displayed when the sales tab is selected. At the top of the page beneath the navigation bar is the business center's location identifier 1804. Below the location identifier is the occupancy report box 1805. The occupancy report box is a rows and column table of occupancy information presented to the business center personnel. The occupancy report box includes a column for date information 806, a column for occupancy workstation percentage 1807, a column for area percentage rented not including non-rentable area 1808, and a column for area percentage rented including non-retable area 1809. The occupancy workstation percentage information specifies the percentage or workstations, for example offices, that are rented. The row of information presented in the occupancy report table corresponds to the date information displayed in the date information cell of the date information column.

While the occupancy report shown in FIG. 18 is for one specific date, the present invention provides for occupancy reports to be generated and displayed according to any range of dates or collection of specific dates, and may include any subset of the business center or group of business centers.

FIG. 19 is a generalized block diagram of the room availability report page 1900. Business center personnel may view details of the availability of business center facilities resources. The room availability details are also used by business center staff to manage the business center including managing staffing, managing assigned tasks and work load, managing business center facilities pricing and special offers, managing promotional activities and advertising, and the like.

Business center personnel may reach the room availability report page 1900 by clicking on the report tab 1901, and the sales tab 1902 which is displayed when the report tab is selected, and the room availability tab 1903 which is displayed when the sales tab is selected. At the top of the page beneath the navigation bar is the business center's location identifier 1904. Below the location identifier is the room availability report box 1905.

The room availability report box 1905 is a table with columns indicating the suite 906, suite description 1907, suite size 1908, number of persons accommodated by the suite 1909, the name of the corporate client renting the suite 1910, the name of the individual or employee of the client renting the suite 1911, the beginning of the rental period, the contract date, 1912, the end of the rental period, or end of the contract date, 1913, the term used in the rental contract (such as daily, weekly, monthly, yearly, etc.) 1914, the asking price for the suite 1915, the current price the suite is renting for 1916, the full price of the suite 1917, and the difference between the full price 1917 and the asking price 1915.

The rows of the table in the room availability report box indicate the particular suite, and the information in the cells of the tale correspond to the suite and the column indicator.

Below the room availability report box 1905 is a room availability summary report box 1919. The room availability summary report box is a table with rows for workstations 1920, rooms 1921, rent amount 1922, rent amount without including non-rentable area 1923, rental amount including non-rentable area 1924. The room availability summary report box table includes columns for available facilities resources 1925, vacant facilities resources 1926, occupied facilities resources 1927, and percentage of available facilities resources 1928.

The room availability report page 1900 provides business center personnel with a quick view of the booked status of the business center's facilities resources. Additionally, the present invention provides business center personnel with a concise and easy to read report on the relevant information including contract start and end dates, rental amount, room characteristics such as size and type, as well as any other information on the business center's facilities resources personnel may desire.

### Presenting and Selecting Business Center Equipment

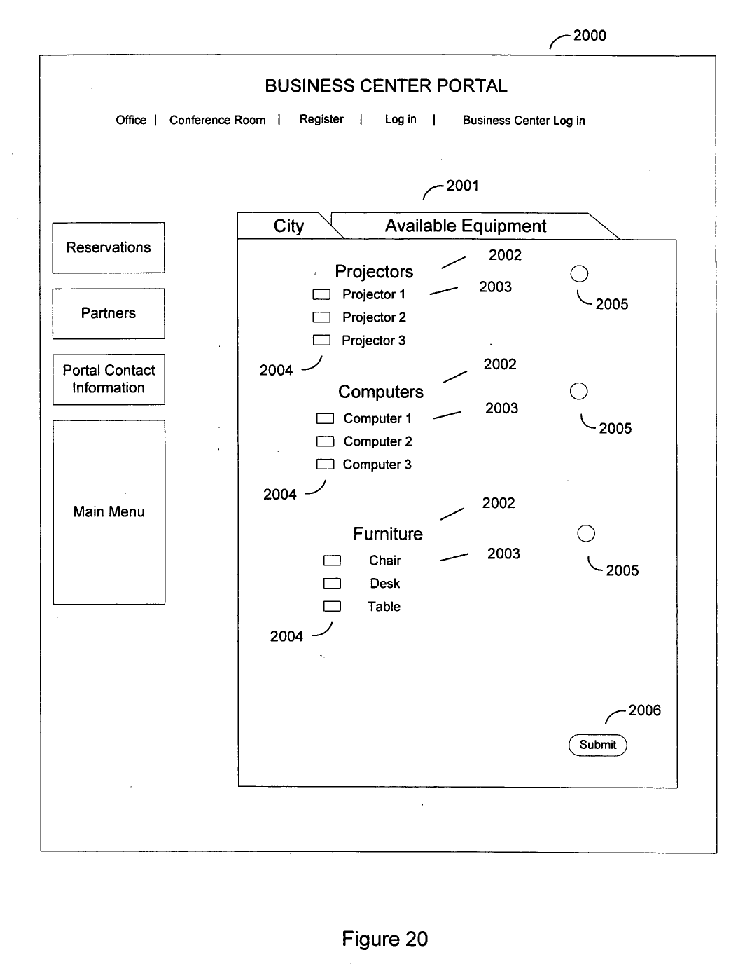

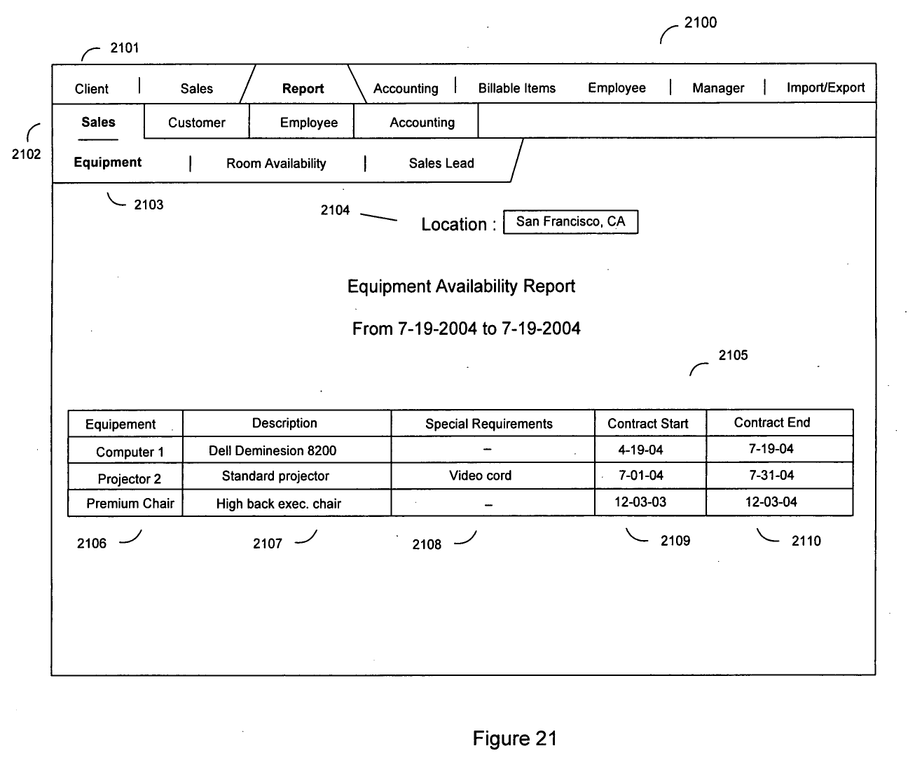

FIGS. 20-21 illustrate the equipment selection and report pages. The present invention provides a web accessible portal for visitors to search for, view, reserve and book business center equipment. In addition to renting business center facilities resources such as offices, conference rooms, training rooms, and the like, business center customers also rent equipment for their use during their stay in the business center. For example, a business center client may choose to rent a computer for use in an office, a second computer for use in a training room, and a projector for use in the training room.

FIG. 20 is a generalized block diagram of the equipment selection page 2000. A business center client or visitor to the business center portal would typically view equipment selection page 2000 after booking a business center facilities resource, but the portal may allow visitors to view available equipment prior to a booking.

In the event the visitor views the equipment selection page after making a booking, or after logging in to the portal so that the system is aware of their bookings, when the visitor is presented with the equipment selection page 2000 the equipment shown will only be the equipment which is available for rental during the client's booked stay. Alternatively, all equipment available at a facility could be presented to a visitor and a date selection page could be used to confirm the availability of the equipment the visitor selects for confirmation of availability.

Equipment selection page 2000 includes an available equipment display box 2001. The available equipment display box includes a list of the equipment available at the business center on during the booking of the client. The available equipment is arranged by category under the equipment category heading indicators 2002. Examples of equipment categories include computers, projectors, audio-visual equipment, projectors, video conferencing equipment, speakerphones, copiers, shredders, fax machines, scanners, furniture (such as chairs, desks, couches, tables, bookcases, etc.), or any other form of equipment a business center client may wish to rent. Below the equipment category heading indicators are the individual pieces of equipment indicated by the equipment identifiers 2003. Alternatively, the equipment identifiers could identify groups of equipment or equipment packages (several pieces of equipment rented as a package) where appropriate. A visitor wishing to select a piece of equipment or several pieces of equipment for rental selects according to their preferences by checking the appropriate equipment selector 2004. Once the visitor has made their selections they may proceed to book the selected equipment for rent during their stay by clicking on the submit button 2006. As users may not need a piece of equipment for their entire stay, the booking process allows the visitor to specify the exact dates and times they will need the equipment using a date and time selector similar to those illustrated in FIGS. 6 and 7.

FIG. 21 is a generalized block diagram of the equipment availability report page 2100. Business center personnel may view details of the availability of business center facilities equipment using the equipment availability report page 2100. The equipment availability details are also used by business center staff to manage the business center including managing staffing, managing assigned tasks and work load, managing equipment inventory and maintenance, managing business center equipment pricing and special offers, managing promotional activities and advertising, and the like.

Business center personnel may reach the room availability equipment page 2100 by clicking on the report tab 2101, and the sales tab 2102 which is displayed when the report tab is selected, and the equipment availability tab 2103 which is displayed when the sales tab is selected. At the top of the page beneath the navigation bar is the business center's location identifier 2104. Below the location identifier is the equipment availability report box 1905. The equipment availability report box contains a table with columns for equipment 2106, equipment description 2107, special requirements for renting or using the equipment 2108, contract start date, or the first date the equipment will be used by the client, 2109, and contract end date, or the last day the equipment will be used by the client, 2110. Additionally, the equipment availability report box may contain information on the time slot the equipment is being rented, for equipment rented by the hour or portion of a day. Other details, such as rental amount, asked rental price, or other information may also be included in other embodiments of the equipment availability report.

The equipment availability report page 2100 provides business center personnel with a quick view of the booked status of the business center's equipment resources. Additionally, the present invention provides business center personnel with a concise and easy to read report on the relevant information including contract start and end dates, rental amount, equipment characteristics, as well as any other information on the business center's personnel may desire.

In addition to viewing the availability of business center equipment, the present invention allows business center personnel to edit and create the equipment information stored by the business center portal. Using a page similar to the plan maintenance page 1500 shown in FIG. 15, business center personnel may create a new equipment item for rent, may create a new category of equipment to rent, and may make changes to the information on individual items of equipment or to categories of equipment. The present invention stores this information in a manner associated with the particular business center, including the location or locations of the business center. In this manner the request for available equipment will return to a visitor the equipment available for that business center at the location the visitor is interested in and during the time the visitor is interested in.

### Presenting and Selecting Business Center Services

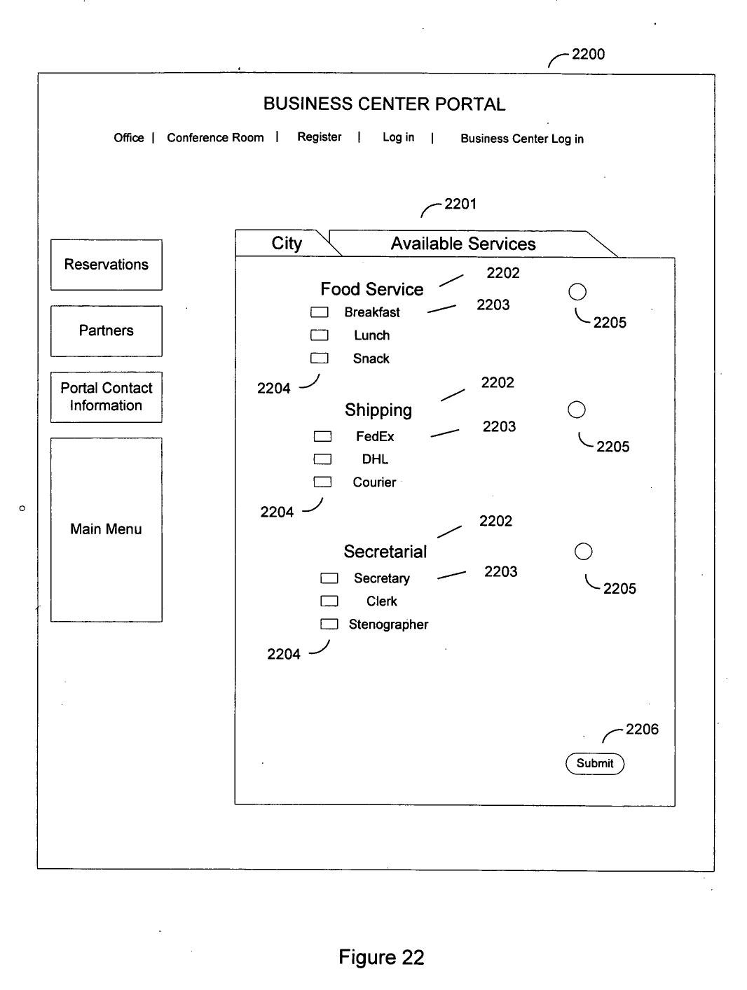

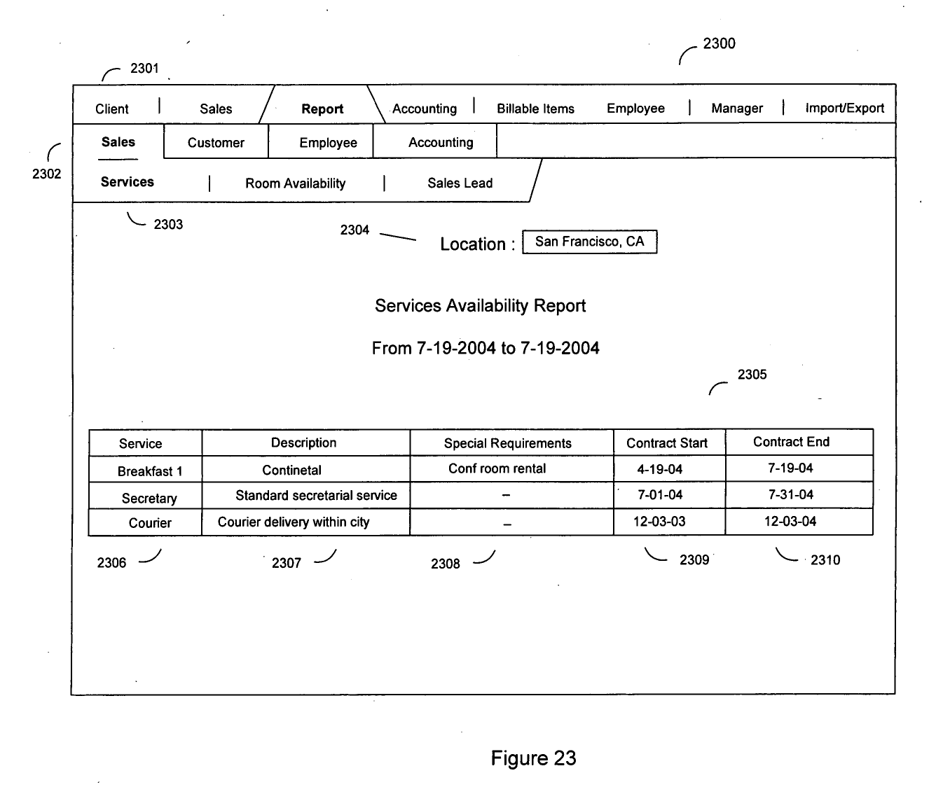

FIGS. 22-23 illustrate the service selection and report pages. The present invention provides a web accessible portal for visitors to search for, view, reserve and book business center services. In addition to renting business center facilities resources such as offices, conference rooms, training rooms, and the like, business center customers also rent services during their stay in the business center. For example, a business center client may choose to have a secretary and provide breakfast service for a morning meal.

FIG. 22 is a generalized block diagram of the service selection page 2200. A business center client or visitor to the business center portal would typically view service selection page 2200 after booking a business center facilities resource, but the portal may allow visitors to view available services prior to a booking.

In the event the visitor views the service selection page after making a booking, or after logging in to the portal so that the system is aware of their bookings, when the visitor is presented with the service selection page 2200 the services shown will only be the services which are available during the client's booked stay. Alternatively, all services available at a facility could be presented to a visitor and a date selection page could be used to confirm the availability of the services the visitor selects for confirmation of availability.

Service selection page 2200 includes an available service display box 2201. The available service display box includes a list of the services available at the business center on during the booking of the client. The available services are arranged by category under the service category heading indicators 2202. Examples of service categories include secretarial services, food services, shipping services, equipment setup services, faxing, copying, typing, or any other services a business center client may wish to use. Below the service category heading indicators are the particular services indicated by the service identifiers 2003. Alternatively, the service identifiers could identify groups of services or service packages (several services rented as a package) where appropriate. A visitor wishing to select a service or several services for rental selects according to their preferences by checking the appropriate service selector 2204. Once the visitor has made their selections they may proceed to book the selected services for rent during their stay by clicking on the submit button 2206. As users may not need a service for their entire stay, the booking process allows the visitor to specify the exact dates and times they will need the service using a date and time selector similar to those illustrated in FIGS. 6 and 7.

FIG. 23 is a generalized block diagram of the service schedule report page 2300. Business center personnel may view details of the availability of business center facilities services using the service schedule report page 2300. The service schedule details are also used by business center staff to manage the business center including managing staffing, managing assigned tasks and work load, managing inventory and maintenance, managing business center service pricing and special offers, managing promotional activities and advertising, and the like.

Business center personnel may reach the service schedule report page 2300 by clicking on the report tab 2301, and the sales tab 2302 which is displayed when the report tab is selected, and the services tab 2303 which is displayed when the sales tab is selected. At the top of the page beneath the navigation bar is the business center's location identifier 2304. Below the location identifier is the service schedule report box 2305. The equipment availability report box contains a table with columns for services 2306, service description 2307, special requirements for using the service 2308, contract start date, or the first date the service will be used by the client, 2309, and contract end date, or the last day the service will be used by the client, 2110. Additionally, the service schedule report box may contain information on the time slot the service is being provided, for services rented by the hour or portion of a day. Other details, such as rental amount, asked rental price, or other information may also be included in other embodiments of the service schedule report.

The service schedule report page 2300 provides business center personnel with a quick view of the booked status of the business center's services. Additionally, the present invention provides business center personnel with a concise and easy to read report on the relevant information including contract start and end dates, rental amount, service characteristics, as well as any other information on the business center's personnel may find useful.

In addition to viewing the availability of business center services, the present invention allows business center personnel to edit and create the service information stored by the business center portal. Using a page similar to the plan maintenance page 1500 shown in FIG. 15, business center personnel may create a new service item for rent, may create a new category of services to rent, and may make changes to the information on individual service items or to categories of services. The present invention stores this information in a manner associated with the particular business center, including the location or locations of the business center. In this manner the request for available services will return to a visitor the services available for that business center at the location the visitor is interested in and during the time the visitor is interested in.

The present invention provides for the synchronization between the business center portal and the business center servers used by independent or affiliated business centers to book, bill and manage their business centers. Alternatively, business centers may elect to use the business center portal to book, bill and manage their business center, or may use the business center portal for a portion of these functions while using their own business center servers for the remaining tasks.

While the above embodiments were described in the context of web accessible pages viewed through and internet browser, alternate embodiments could use other technologies or client side agents, to provide access to the pages and functionality described in the present application.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

We claim:

1. A method of managing a business center using a business center portal, the business center portal capable of providing visitors with information specifying available business center facilities resources and booking said available business center facilities resources, comprising:
providing business center personnel with a report specifying the availability of their available business center facilities resources,
receiving information specifying a change in the availability of at least one business center facilities resource from a computer used by a business center personnel;
updating the information in the business center portal according to the received change.

2. The method of claim 1, wherein the business center personnel must log in prior to receiving the report, and wherein the report only provides availability information for the business center associated with the access permissions of the business center personnel.

3. The method of claim 1, wherein the business center personnel must log in prior to the receipt of information specifying a change in the availability of at least one business center facilities resource, and wherein the update is performed only if the business center personnel associated with the receipt of changed availability information has access permission to make such an update.

4. The method of claim 1, wherein the change information includes a change in the availability of an existing business center facilities resource.

5. The method of claim 1, wherein the change information includes the addition of an available business center facilities resource.

6. The method of claim 1, wherein the change information includes a change in the rental price of an existing business center facilities resource.

7. The method of claim 1, wherein the change information includes a change in the availability of an existing business center service.

8. The method of claim 1, wherein the change information includes the addition of an available business center service.

9. The method of claim 1, wherein the change information includes a change in the rental price of an existing business center service.

10. The method of claim 1, wherein the availability is based upon a prior synchronization between a database of the business center portal and the database of at least one independent business center.

11. The method of claim 10, wherein the synchronization updates the database of the independent business center to reflect the bookings made at the business center portal.

12. The method of claim 10, wherein the synchronization updates the database of at least one independent business center is updated to include change information entered at the business center portal by personnel of the business center.

12. The method of claim 1, wherein the change information includes a change in the availability of existing business center equipment.

13. The method of claim 1, wherein the change information includes the addition of available business center equipment.

14. The method of claim 1, wherein the change information includes a change in the rental price of a existing business equipment.

15. An method of operating an online reservation and management system for business centers, comprising:
retrieving availability information from a database of at least one independent business center, the availability information specifying the availability of business center facilities resources;
updating a database of the online reservation and management system for business centers;
presenting the updated availability information to visitors to the online reservation and management system for business centers;
booking an available business center facilities resource at the at least one independent business center in response to a booking request from said visitor;
updating the database of the online reservation and management system for business centers in response to said booking, said update include the change in the availability status as a result of said booking; and
providing a report available to personnel from the at least one independent business center, the report indicating the booking of the business center facilities resource.

16. The method of claim 15, wherein the report includes all of the bookings for a specified period of time.

17. The method of claim 16, wherein the report identifies all of the bookings for the specified period of time at a particular location of the at least one independent business center.

18. The method of claim 15, wherein the booking for a service also includes a booking for business center equipment.

19. An method of operating an online reservation and management system for business centers, comprising:
retrieving availability information from a database of at least one independent business center, the availability information specifying the availability of business center service;
updating a database of the online reservation and management system for business centers;
presenting the updated availability information to visitors to the online reservation and management system for business centers;
booking an available business center service at the at least one independent business center in response to a booking request from said visitor;
updating the database of the online reservation and management system for business centers in response to said booking, said update include the change in the availability status as a result of said booking; and
providing a report available to personnel from the at least one independent business center, the report indicating the booking of the business center service.

20. The method of claim 19, wherein the booking for a service also includes a booking for business center equipment.
